(19) United States
(12) Patent Application Publication
(10) Pub. No.: US 2010/0095198 A1
(43) Pub. Date: Apr. 15, 2010

(54) SHARED COMMENTS FOR ONLINE DOCUMENT COLLABORATION

(75) Inventors: Michael Bultrowicz, Vancouver (CA); Boris Smus, Richmond (CA)

Correspondence Address: PVF -- APPLE INC.;c/o PARK, VAUGHAN & FLEMING LLP, 2820 FIFTH STREET, DAVIS, CA, 95618-7759, US

(73) Assignee: APPLE INC., Cupertino, CA (US)

(21) Appl. No.: 12/252,033

(22) Filed: Oct. 15, 2008

(51) Int. Cl. G06F 17/24

(52) U.S. Cl. 715/234; 715/255

(57) ABSTRACT

Some embodiments of the present invention provide a system that edits a document. During operation, the system shares the document as a webpage and receives, from the webpage, a comment for the document by a collaborator of the document. Next, the system updates the webpage with the comment and enables responses to the comment by other collaborators of the document from the webpage.

### RELATED APPLICATION

The subject matter of this application is related to the subject matter in a co-pending non-provisional application by inventor Mac Murrett entitled “Creating a Text-Editable Web Page Using a Word Processor,” having Ser. No. 12/109,538, and filing date 25 Apr. 2008 (Attorney Docket No. APL-P6054US1).

### BACKGROUND

1. Field of the Invention

The present invention relates to techniques for editing documents. More specifically, the present invention relates to techniques for sharing comments in web-editable documents.

2. Related Art

On-line networks, such as the Internet or World Wide Web (WWW), are increasingly popular forums for exchanging information and communicating with individuals and organizations. For example, many users publish their own web pages to keep in contact with their friends, colleagues and family members.

Moreover, word-processing programs are also widely used to generate documents, which can include a wide variety of content, including text and images. Additionally, these programs provide advanced features, such as tools for integrating text with embedded images in a complicated framework or layout.

Unfortunately, it is currently difficult to use a word-processing program to generate a web page that includes such advanced features because the word-processing program (or a related interpreter program) is typically needed to interpret the framework information in output files from the word-processing program, and this functionality is typically not included in web browsers.

Additionally, it is often difficult for users to interact with a web page to provide comments or feedback on the web-page content.

Hence, what is needed is a method and an apparatus that facilitates publishing documents without the above-described problems.

### SUMMARY

Some embodiments of the present invention provide a system that edits a document. During operation, the system shares the document as a webpage and receives, from the webpage, a comment for the document by a collaborator of the document. Next, the system updates the webpage with the comment and enables responses to the comment by other collaborators of the document from the webpage.

In some embodiments, the system also merges the comment into the document.

In some embodiments, the system also receives a response to the comment from one of the other collaborators and updates the comment with the response.

In some embodiments, sharing the document involves receiving an export instruction from a publisher of the document and generating the webpage from the document based on the export instruction.

In some embodiments, the system also enables responses to a native comment within the document from the webpage. In these embodiments, the native comment is created by a publisher of the document.

In some embodiments, the publisher is associated with at least one of enabling the comment, enabling the responses to the comment, and enabling the responses to the native comment.

In some embodiments, the document corresponds to a word-processing document, a spreadsheet, or a presentation.

In some embodiments, the comment corresponds to a general comment, a floating comment, a cell comment, an image comment, or a text-based comment.

### BRIEF DESCRIPTION OF THE FIGURES

FIG. 1 shows a schematic of a system in accordance with an embodiment of the present invention.

FIG. 2A shows an exemplary screenshot in accordance with an embodiment of the present invention.

FIG. 2B shows an exemplary screenshot in accordance with an embodiment of the present invention.

FIG. 2C shows an exemplary screenshot in accordance with an embodiment of the present invention.

FIG. 2D shows an exemplary screenshot in accordance with an embodiment of the present invention.

FIG. 3 shows a flowchart illustrating the process of editing a document in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Embodiments of the present invention provide a method and system for editing documents. Documents may include, for example, word-processing documents, spreadsheets, presentations, and/or other documents that may be created using an office suite. As a result, the documents may be created and/or edited using document editors such as word-processing applications, spreadsheet applications, email clients, presentation applications, and/or graphics suites.

More specifically, embodiments of the present invention provide a method and system for sharing comments in a document. The document may be shared as a webpage with one or more collaborators of the document. Comments for the document may be obtained from the collaborators through the webpage and/or obtained as native comments from a publisher of the document. The webpage may be updated with the comments to allow the other collaborators to view the comments and respond to the comments. Furthermore, comments and responses may be displayed using comment threads that allow multiple collaborators to discuss text, images, cells, pages, and/or other areas of the document. Finally, the comments may be merged into the document from the webpage to facilitate collaboration on the document and/or update of the document based on the comments.

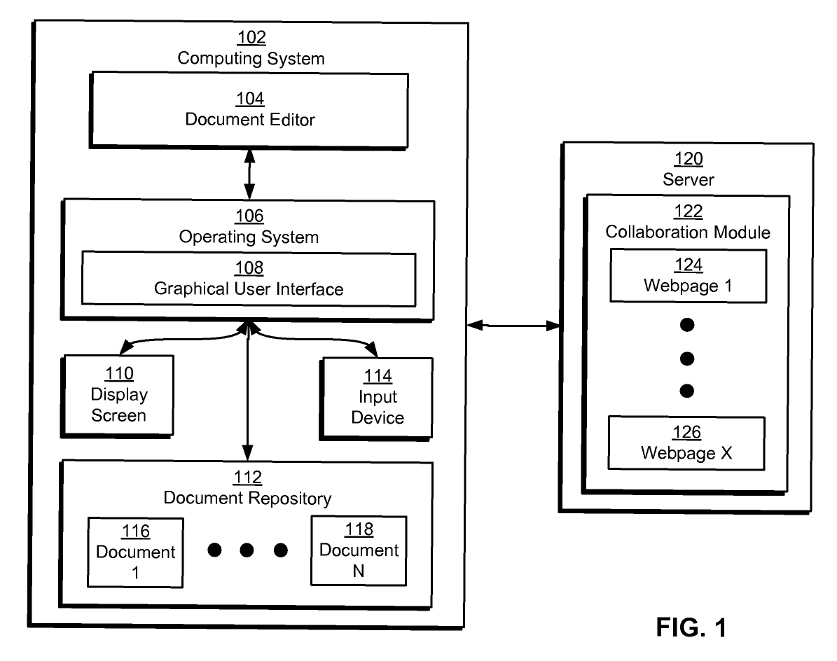

FIG. 1 shows a schematic of a system in accordance with an embodiment of the present invention. As shown in FIG. 1, the system includes a computing system 102 and a server 120. The interaction between computing system 102 and server 120 may facilitate collaboration on documents and/or sharing of comments for documents, as explained in further detail below.

Computing system 102 may correspond to an electronic device that provides one or more services or functions to a user. For example, computing system 102 may operate as a mobile phone, personal computer (PC), global positioning system (GPS) receiver, portable media player, personal digital assistant (PDA), and/or graphing calculator. In addition, computing system 102 may include an operating system 106 that coordinates the use of hardware and software resources on computing system 102, as well as one or more applications perform specialized tasks for the user. For example, computing system 102 may include applications such as an email client, address book, document editor 104, and/or media player. To perform tasks for the user, applications may obtain the use of hardware resources (e.g., processor, memory, I/O components, wireless transmitter, etc.) on computing system 102 from operating system 106, as well as interact with the user through a hardware and/or software framework provided by the operating system, as described below.

To enable interaction with the user, computing system 102 may include one or more hardware input/output (I/O) components, such as display screen 110 and an input device 114. Each hardware I/O component may additionally be associated with a software driver (not shown) that allows operating system 106 and/or applications on computing system 102 to access and use the hardware I/O components.

Display screen 110 may be used to display images and/or text to one or more users of computing system 102. In one or more embodiments of the invention, display screen 110 serves as the primary hardware output component for computing system 102. For example, display screen 110 may allow the user(s) to view menus, icons, windows, emails, websites, videos, pictures, maps, documents (e.g., document 1 116, document n 118), and/or other components of a graphical user interface (GUI) 108 provided by operating system 106. Those skilled in the art will appreciate that display screen 110 may incorporate various types of display technology to render and display images. For example, display screen 110 may be a liquid crystal display (LCD), an organic light-emitting diode (OLED) display, a surface-conducting electron-emitter display (SED), and/or other type of electronic display.

Input device 114 may function as the primary hardware input component of computing system 102. Specifically, input device 114 may allow the user to point to and/or select one or more areas of display screen 110 using a cursor, highlight, and/or other visual indicator. Input provided by the user using input device 114 may be processed by the corresponding software driver and sent to operating system 106 and/or one or more applications (e.g., transaction application 104) as one or more actions.

Input device 114 may receive user input through various methods, including touchscreens, touchpads, buttons, voice recognition, keypads, keyboards, and/or other input methods. In addition, multiple input devices may exist on computing system 102. Operating system 106 and/or applications on computing system 102 may use the input from the input device(s) to perform one or more tasks, as well as update GUI 108 in response. Images corresponding to GUI 108 may be sent by operating system 106 to a screen driver (not shown), which may display the images on display screen 110 as a series of pixels. As a result, the user may interact with computing system 102 by using input device 114 to provide input to operating system 106 and/or applications and receiving output from operating system 106 and/or applications through display screen 110.

As mentioned previously, computing system 102 may include a document editor 104 that allows the user to create, view, and edit documents (e.g., document 1 116, document n 118). For example, document editor 104 may correspond to a word-processing application, spreadsheet application, presentation application, graphics suite, and/or email client. Documents created using document editor 104 may include flyers, brochures, posters, emails, spreadsheets, presentations, letters, and/or catalogs. The documents may be stored locally (e.g., on a hard disk drive) on computing system in a document repository 112 that is accessible to document editor 104. Alternatively, the documents may be stored in a location (e.g., server 120) that is external to computing system 102 and accessed via a network connection with computing system 102.

Document editor 104 may additionally facilitate document sharing and collaboration between the user and other collaborators. For example, document editor 104 may allow the user to send a document (e.g., via email) to the other collaborators, receive comments for the document from the collaborators, and update the document based on the comments.

Document editor 104 may further enable online sharing of the document. In particular, document editor 104 may allow the user to share (e.g., publish) the document as a webpage with collaborators of the document. The layout of images, text, and/or other information on the webpage may further replicate the layout of the document as shown within document editor 104. Moreover, changes made to the webpage may be incorporated back into the document. Online sharing of documents using webpages is described in a co-pending non-provisional application by inventor Mac Murrett entitled “Creating a Text-Editable Web Page Using a Word Processor,” having Ser. No. 12/109,538, and filing date 25 Apr. 2008 (Attorney Docket No. APL-P6054US1), which is incorporated herein by reference.

In one or more embodiments of the invention, documents created using document editor 104 are shared as webpages using server 120. Document editor 104 may generate one or more webpages (e.g., webpage 1 124, webpage x 126) from each document and send the webpages to server 120 using a network connection with server 120. The webpages may be generated in response to an export instruction from the user and/or another publisher of the document. For example, the user may generate an export instruction for publishing the first ten pages of a catalog as webpages to server 120. Upon receiving the export instruction, document editor 104 may generate the webpages from the catalog and send the webpages to server 120 for viewing, updating, and/or commenting by collaborators of the catalog.

In one or more embodiments of the invention, sharing of documents from document editor 104 is facilitated by a collaboration module 122 in server 120. For example, collaboration module 122 may handle requests (e.g., HyperText Transfer Protocol (HTTP) requests) for the webpages corresponding to the documents from collaborators of the documents. Collaboration module 122 may also verify access privileges to each document prior to transmitting the webpage(s) for the document to the collaborator requesting the document.

Furthermore, collaboration module 122 may allow collaborators to make changes to the webpages. For example, collaboration module 122 may receive comments for a document through the webpage(s) for the document. Collaboration module 122 may also update the webpage(s) with the comments to allow other collaborators to view the comments. Finally, collaboration module 122 may transmit the comments to document editor 104, which in turn may incorporate the comments into the document. For example, document editor 104 may write the comments to a file corresponding to the document in document repository 112.

Those skilled in the art will appreciate that document sharing, export, and merging using webpages may be implemented in multiple ways. For example, webpages may be generated from documents in document repository 112 using collaboration module 122, server 120, and/or another component associated with document editor 104 and/or server 120. Similarly, comments and/or other changes to the webpages (e.g., webpage 1 124, webpage x 126) may be merged into the corresponding documents via pushes from server 120 or pulls from document editor 104. Finally, webpages for each document may be provided to the collaborators using multiple servers and/or devices with network connectivity instead of a single server (e.g., server 120).

As mentioned previously, changes to webpages on server 120 may include comments for documents created using document editor 104. Each comment may correspond to a general (e.g., document-wide) comment, a floating comment for a specific page of a document, and/or a cell comment associated with one or more table cells of a document (e.g., a spreadsheet). Comments may also include an image comment for one or more images in a document and/or a text-based comment related to a selection of text within a document.

Furthermore, as discussed in the above-referenced application, comments for a document may be provided through a web browser displaying one or more webpages pertaining to the document. For example, a collaborator on a document may provide a text-based comment by highlighting text within a webpage representing the document and typing the comment into a box associated with the highlighted text. Collaboration module 122 may then update the webpage and/or the document with the text-based comment so that the publisher (e.g., the user of computing system 102) and/or other collaborators may view the comment.

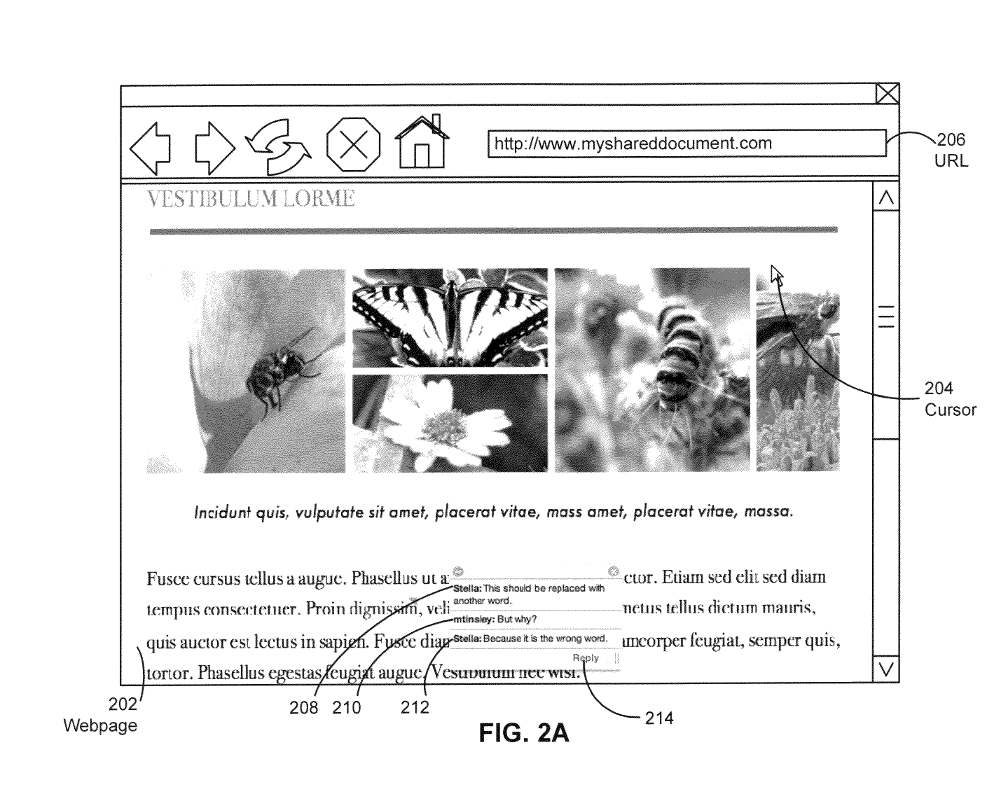

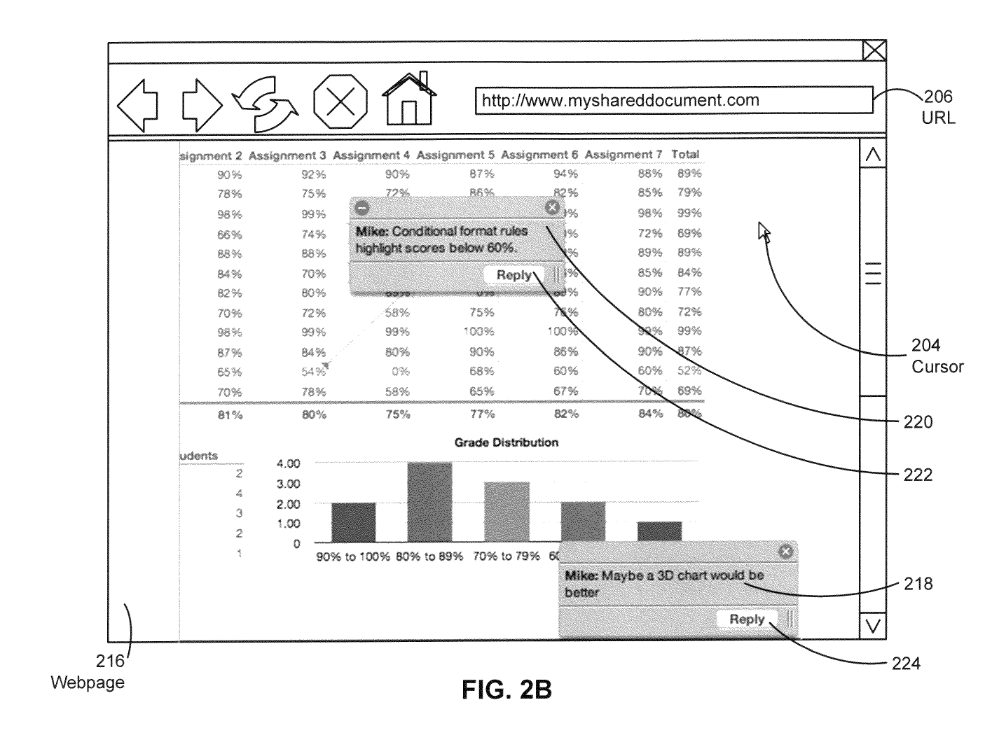

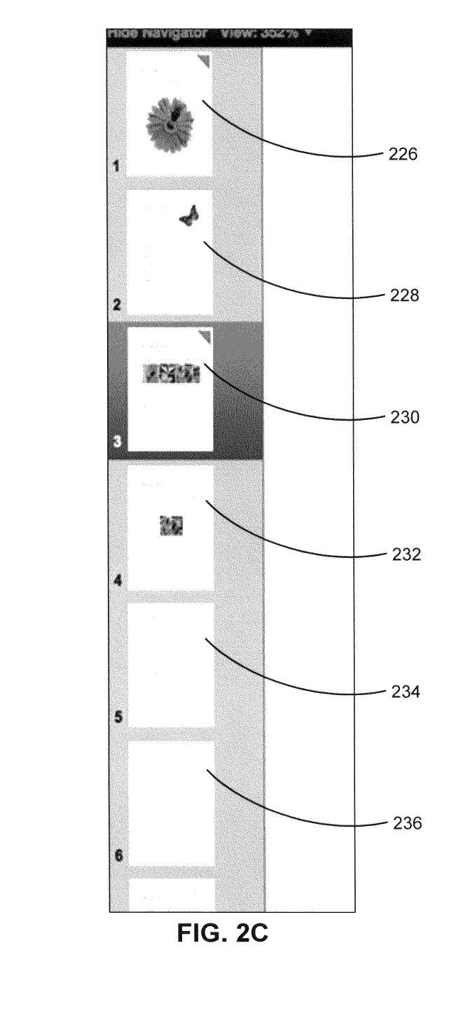

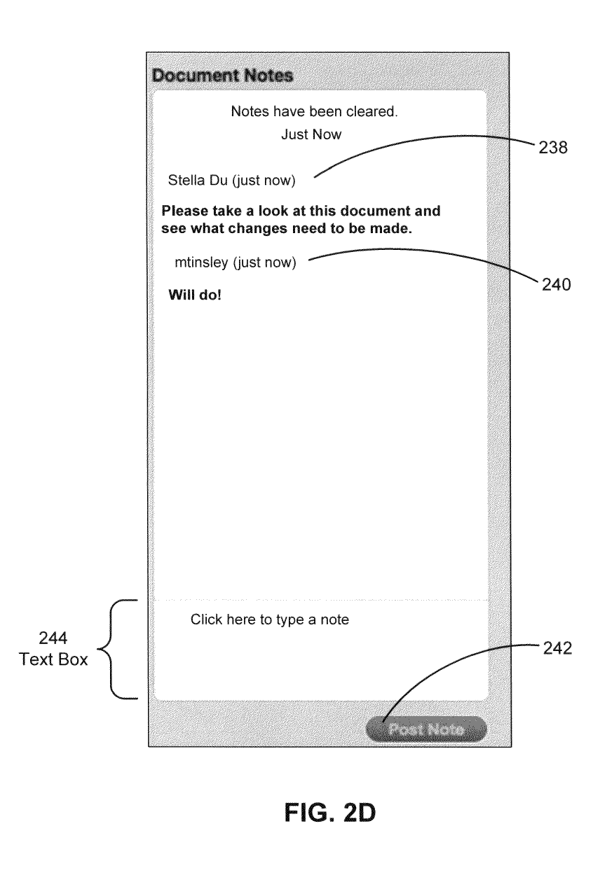

Collaboration module 122 may also allow collaborators to respond to comments for a document. In particular, collaboration module 122 may allow a collaborator to provide a response to a comment for the document through the webpage for the document. Collaboration module 122 may then update the comment with the response in the webpage to facilitate discussion of the document. Display of comments and responses for documents is discussed in further detail below with respect to FIGS. 2A-2D.

For example, responses may be displayed in the webpage (e.g., in a box) below the comment in the order in which they were received. In other words, collaboration module 122 may display dialogues (e.g., conversations, threads, etc.) related to a particular part (e.g., a text selection, an image, a cell, a page, etc.) of the document from multiple collaborators within the webpage for the document. As with individual comments, the dialogues may also be merged into the document and used by the publisher to update the document. Furthermore, the publishing of such dialogues through a single source (e.g., the webpage for the document) rather than from multiple sources, versions, and/or files may facilitate the instantaneous retrieval and consolidation of comments by multiple collaborators, as well as the update of the document based on the comments by the publisher.

Collaborators may also respond to native comments created by the publisher within the document. For example, the publisher may use document editor 104 to create a presentation. The publisher may also use document editor 104 to add a native comment to the presentation asking for input regarding the title of the presentation. When the presentation is exported to server 120, the native comment is included in the webpage corresponding to the presentation for viewing and response by other collaborators of the presentation.

Furthermore, the publisher may enable or disable online comments, responses to online comments, and/or responses to native comments by one or more collaborators of a document. More specifically, the allowance or denial of reviewing and/or commenting capabilities may be provided by the publisher in the export instruction for the document. For example, the publisher may use an export instruction to grant access to the webpage for the document to ten collaborators, creation of and/or responding to online comments to five of the ten collaborators, and responses to native comments to two of the ten collaborators. The publisher may also grant or deny other privileges to collaborators of the document, such as downloading of the document in one or more formats from server 120, uploading of newer/updated versions of the document for sharing on server 120, and/or other modification privileges associated with webpages on server 120. Finally, the publisher may update access privileges to the document using document editor 104, collaboration module 122, and/or another component associated with the sharing of the document.

FIG. 2A shows an exemplary screenshot in accordance with an embodiment of the present invention. More specifically, FIG. 2A shows a screenshot of a web-based user interface for reviewing and commenting a document. As shown in FIG. 2A, the web-based user interface is provided by a webpage 202 within a web browser. Furthermore, webpage 202 may be obtained from a Universal Resource Locator (URL) 206 by the web browser. For example, webpage 202 may correspond to a shared representation of a document (e.g., a catalog) located at URL 206. As described above, the document may be uploaded to a server associated with URL 206 by a publisher of the document and provided as webpage 202 to enable reviewing and/or commenting by collaborators of the document.

As shown in FIG. 2A, webpage 202 includes a box containing a comment 208 and two responses 210-212 to comment 208. Comment 208 is shown beside highlighted text in webpage 202, indicating that comment 208 is a text-based comment. Furthermore, comment 208 may be created by selecting the text using a cursor 204 and inputting text (e.g., “This should be replaced with another word.”) into a box provided by webpage 202. Comment 208 may also be updated with response 210 (e.g., “But why?”) and response 212 (e.g., “Because it is the wrong word.”) by selecting a button 214 (e.g., “Reply”) and entering text into another box provided by webpage 202.

As a result, comment 208 and responses 210-212 may be concurrently viewed by multiple collaborators of the document and updated with additional responses within webpage 202 as the responses are received. In other words, webpage 202 may facilitate the creation and consolidation of dialogues between multiple collaborators of the document while avoiding issues related to distributing multiple files for the document, obtaining comments from multiple locations, and/or synchronizing comments from multiple collaborators. For example, webpage 202 may allow a discussion related to the highlighted text to be opened by a first collaborator (e.g., “Stella”) using comment 208. The discussion may then be updated by a second collaborator (e.g., “mtinsley”) with response 210. Finally, the first collaborator may further discuss the highlighted text with the second collaborator by posting response 212.

New comments may also be added to webpage 202. For example, image comments may be added by selecting one or more images in webpage 202, text-based comments may be added by selecting one or more characters in webpage 202, and/or floating comments may be added by selecting other regions of webpage 202. Once review and/or commenting for the document is complete, the comments (e.g., comment 208, responses 210-212) may be merged into the document to facilitated update of the document based on the comments.

FIG. 2B shows an exemplary screenshot in accordance with an embodiment of the present invention. As with FIG. 2A, FIG. 2B shows a web-based user interface for commenting a document. In particular, FIG. 2B shows a webpage 216 representing a spreadsheet document. Moreover, webpage 216 may be accessed by one or more collaborators of the spreadsheet to review the spreadsheet and/or submit comments for the spreadsheet.

As shown in FIG. 2B, webpage 216 includes two comments 218-220. Comment 218 represents a floating comment in the spreadsheet. In other words, comment 218 (e.g., “Maybe a 3D chart would be better”) may be positioned within webpage 216 in a certain area (e.g., page) of webpage 216 without pointing to specific information (e.g., text, cells, images, etc.) in the spreadsheet. Responses to comment 218 may be provided by selecting a button 224 within the box containing comment 218 using cursor 204.

On the other hand, comment 220 (e.g., “Conditional format rules highlight scores below 60%”) corresponds to a cell comment related to a specific cell in the spreadsheet. Consequently, comment 220 includes an arrow to the cell within webpage 216. Responses to comment 220 may be made by selecting button 222 using cursor 204 and/or another input mechanism (e.g., keyboard shortcuts), or by selecting the cell within webpage 216 using cursor 204. Furthermore, responses to comment 220 may be related to comment 220 and/or the cell to which comment 220 points. As with FIG. 2A, new comments for the spreadsheet may similarly be added by selecting cells, text, images, and/or other regions of webpage 216 and entering the comments into boxes (e.g., text boxes) provided by webpage 216.

FIG. 2C shows an exemplary screenshot in accordance with an embodiment of the present invention. In particular, FIG. 2C shows a screenshot of a set of thumbnails 226-236 for a document. Thumbnails 226-236 may correspond to pages of the document and may allow the user to quickly access a specific page by selecting the thumbnail representing the page. As shown in FIG. 2C, thumbnail 230 is selected, indicating that the user may be viewing the page associated with thumbnail 230.

Thumbnails 226-236 may additionally indicate the presence of comments within pages of the document. More specifically, triangles in the upper right corners of thumbnail 226 and thumbnail 230 are shown, signifying that thumbnail 226 and thumbnail 230 may include comments (e.g., native comments, online comments, etc.). The user may thus access comments for the document by selecting the thumbnails for pages that contain comments instead of browsing through the entire document.

FIG. 2D shows an exemplary screenshot in accordance with an embodiment of the present invention. The screenshot of FIG. 2D may correspond to a user interface for viewing and submitting general (e.g., document-wide) comments for a document. Furthermore, the user interface may be accessed through a document editor, such as document editor 104 of FIG. 1, or through a web browser and webpage associated with the document.

As shown in FIG. 2D, the document includes two general comments 238-240. Comment 238 (e.g., “Please take a look at this document and see what changes need to be made.”) is provided by a first collaborator (e.g., “Stella Du”), while comment 240 (e.g., “Will do!”) is in response to comment 238 and is provided by a second collaborator (e.g., “mtinsley”). Additional general comments may be submitted by entering text into a text box 244 (e.g., “Click here to type a note”) provided by the user interface and selecting a button 242 (e.g., “Post Note”) below text box 244. Alternatively, other types of comments for the document, such as text-based comments, image comments, cell comments, and/or floating comments, may be provided by selecting areas within one or more webpages representing the document, as described above.

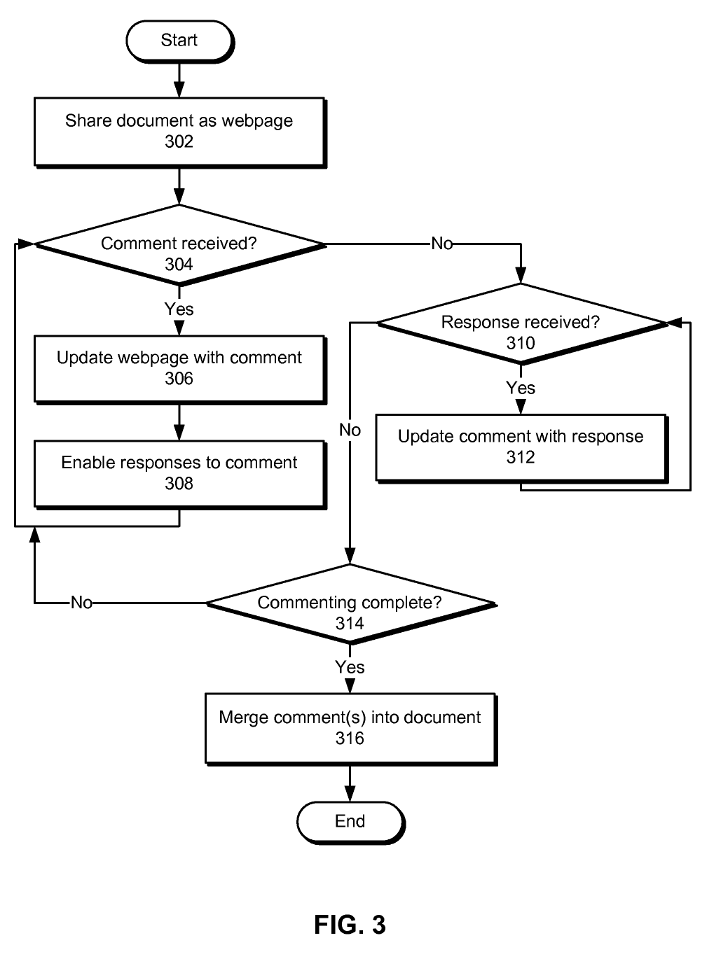

FIG. 3 shows a flowchart illustrating the process of editing a documents in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

First, the document is shared as a webpage (operation 302). The document may correspond to a word-processing document, a spreadsheet, a presentation, and/or another document created using an office suite. To share the document, an export instruction may be received by a publisher of the document, and the webpage may be generated from the document based on the export instruction. Other parameters associated with sharing of the document, such as access, review, and/or commenting privileges by collaborators of the document, may also be obtained from the export instruction.

Once the document is shared, comments for the document may be received (operation 304) from collaborators of the document. Comments may correspond to general comments, text-based comments, image comments, cell comments, and/or floating comments. If a comment is received, the webpage is updated with the comment (operation 306) and responses to the comment are enabled (operation 308). As a result, comments for the document may be viewed instantaneously from the webpage to avoid repetition, while responses to comments may be enabled to facilitate collaboration on and discussion of the document by multiple collaborators.

Similarly, responses to comments may be received (operation 310) during the period in which the document is shared. The responses may be provided for native comments obtained from the document and/or for online comments obtained from the webpage. If a response to a comment is received, the comment is updated with the response (operation 312). In other words, the response is immediately accessible from the webpage containing the comment.

To facilitate collaboration and discussion, comments and responses may continue to be received (operations 304-310) and used to update the webpage until commenting is complete (operation 314). As a result, multiple collaborators in multiple locations may discuss the document by providing comments and responses for the document to the webpage and viewing comments and responses from other collaborators through the webpage. If commenting is complete, the comment(s) and/or responses may be merged into the document (operation 316) for update of the document based on the comments and responses.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for editing a document, comprising:
sharing the document as a webpage;
receiving, from the webpage, a comment for the document by a collaborator of the document;
updating the webpage with the comment; and
enabling responses to the comment by other collaborators of the document from the webpage.

2. The method of claim 1, further comprising:
merging the comment into the document.

3. The method of claim 1, further comprising:
receiving a response to the comment from one of the other collaborators; and
updating the comment with the response.

4. The method of claim 1, wherein sharing the document involves:
receiving an export instruction from a publisher of the document; and
generating the webpage from the document based on the export instruction.

5. The method of claim 4, further comprising:
enabling responses to a native comment within the document from the webpage, wherein the native comment is created by a publisher of the document.

6. The method of claim 5, wherein the publisher is associated with at least one of enabling the comment, enabling the responses to the comment, and enabling the responses to the native comment.

7. The method of claim 1, wherein the document corresponds to a word-processing document, a spreadsheet, or a presentation.

8. The method of claim 1, wherein the comment corresponds to a general comment, a floating comment, a cell comment, an image comment, or a text-based comment.

9. The method of claim 1, wherein the document is shared using an image within the webpage.

10. A system for editing a document, comprising:
a document editor configured to enable creation of the document by a publisher; and
a collaboration module configured to:
share the document as a webpage;
receive, from the webpage, a comment for the document by a collaborator of the document;
update the webpage with the comment; and
enable responses to the comment by other collaborators of the document from the webpage.

11. The system of claim 10, wherein the collaboration module is further configured to merge the comment into the document.

12. The system of claim 10, wherein the collaboration module is further configured to:
receive a response to the comment from one of the other collaborators; and
update the comment with the response.

13. The system of claim 10,
wherein the collaboration module is further configured to enable responses to a native comment within the document from the webpage, and
wherein the native comment is created by the publisher.

14. The system of claim 13, wherein sharing the document involves:
receiving an export instruction from the publisher; and
generating the webpage from the document based on the export instruction.

15. The system of claim 14, wherein the publisher is associated with at least one of enabling the comment, enabling the responses to the comment, and enabling the responses to the native comment.

16. The system of claim 10, wherein the document corresponds to a word-processing document, a spreadsheet, or a presentation.

17. The system of claim 10, wherein the comment corresponds to a general comment, a floating comment, a cell comment, an image comment, or a text-based comment.

18. The system of claim 10, wherein the document is shared using an image within the webpage.

19. A computer-readable storage medium storing instructions that when executed by a computer cause the computer to perform a method for editing a document, the method comprising:
sharing the document as a webpage;
receiving, from the webpage, a comment for the document by a collaborator of the document;
updating the webpage with the comment; and
enabling responses to the comment by other collaborators of the document from the webpage.

20. The computer-readable storage medium of claim 19, the method further comprising:
merging the comment into the document.

21. The computer-readable storage medium of claim 19, the method further comprising:
receiving a response to the comment from one of the other collaborators; and
updating the comment with the response.

22. The computer-readable storage medium of claim 19, wherein sharing the document involves:
receiving an export instruction from a publisher of the document; and
generating the webpage from the document based on the export instruction.

23. The computer-readable storage medium of claim 19, wherein the document corresponds to a word-processing document, a spreadsheet, or a presentation.

24. The computer-readable storage medium of claim 19, wherein the comment corresponds to a general comment, a floating comment, a cell comment, an image comment, or a text-based comment.

25. The computer-readable storage medium of claim 19, wherein the document is shared using an image within the webpage.
